(19) United States
(12) Patent Application Publication
(10) Pub. No.: US 2024/0199293 A1
(43) Pub. Date: Jun. 20, 2024

(54) PACKAGE COMPRISING A SEAL

(71) Applicant: PA.COTTE SA, Pully (CH)

(72) Inventors: Pierre-Alain Cotte, Amberg (DE); Ronan Affre de Saint Rome, Oudon (FR); Alex Rosset, Nantes (FR); Mathieu Porez, Nantes (FR)

(73) Assignee: PA.COTTE SA, Pully (CH)

(21) Appl. No.: 18/287,406

(22) PCT Filed: Apr. 8, 2022
(86) PCT No.: PCT/EP2022/059532

§ 371 Date: Oct. 18, 2023

(30) Foreign Application Priority Data
Apr. 22, 2021 (FR) 2104206

(51) Int. Cl. B65D 55/06; B65D 55/02

(52) U.S. Cl. CPC B65D 55/06; B65D 55/028; B65D 2255/06; B65D 2401/05

(57) ABSTRACT

The invention relates to a parcel comprising:
a container having a cavity;
closing means, the parcel having a closed configuration in which the closing means prevent access to the cavity, and an open configuration in which the closing means allow access to the cavity;
a seal intended to guarantee a holding of the parcel in its closed configuration, the seal comprising a component for controlling the integrity of the seal;
an electronic unit for controlling the integrity of the seal, the electronic unit comprising means for detecting a degradation of the control component, and means for initiating the detection means during a positioning of the seal in its attached position.

The field of the invention is that of logistics. More specifically, the field of the invention is that of the design and manufacture of secure parcels, and of traceability systems making it possible to control the condition of the parcel in real time.

The invention more specifically relates to parcels provided with seals.

The parcels allow conveying objects within a supply chain.

In general, a parcel is a container defining a cavity in which one or more objects are intended to be positioned during a conveyance.

The parcels also comprise means for closing the parcel to prevent access to the cavity and to its contents.

For example, a parcel can be formed by a case defining the cavity, as well as by a lid movably or removably mounted on the case, or by one or more flaps presented by the case itself. Boxes or cardboards are conventionally used to form such parcels.

In general, it is important to be able to control and/or guarantee the conformity, the presence and the origin of the contents of the parcels.

For this purpose, securing means may be used on the parcels.

In particular, seals can be affixed to the parcels to check that they have not been opened.

The seals conventionally constitute a device fixed to an item to be safeguarded (for example a document, a package, premises, etc.) in such a way that it is impossible, without breaking and damaging the seal, to proceed with the opening of this item.

A seal may consist of a single stamp stamped with a mark, such as a wax seal protecting an authentic document, or even a lead seal of the type protecting water or energy consumption meters.

According to one example of a seal, the plastic labels stuck on the two parts of a casing intended to be spaced apart from each other to allow access to the contents of the casing are known. These plastic labels have a through dotted cutout extending along an interface between the two parts of the casing. The opening of the casing then involves tearing of the label along the dotted cutout, thereby meaning voluntary or accidental opening of this casing.

According to another example of a seal, plastic seals are known which make it possible to guarantee the holding of postal bags, containers or metal boxes in a closed configuration. These seals are generally made of plastic material and comprise a body and a link extending from the body. The link is relatively flexible and is intended to form a loop then to be engaged in a complementary opening presented by the body. The opening and the link are designed in such a way that the introduction of the link into the opening is irreversible, and that only an irreversible deterioration of the seal allows the opening of the loop.

A seal thus comprises, according to a classic design, a part that is irreversibly degradable during the the opening of the item to which the seal is affixed.

Such seals are particularly simple to manufacture and implement.

These seals are designed to be used in various situations, for various types of objects or containers, and can thus be qualified as “generic”.

Nevertheless, there appears to be a desire for more specific integration of a seal on a parcel, and in particular on parcels called “reusable” parcels.

In addition, the seals previously described do not make it possible to know with accuracy, in particular in real time or non-real time by timestamp, when an object has been opened, or even to know the condition of the seal without a visual consultation directly made on the sealed object, sometimes or often impossible.

In the field of the invention, it is also known to use labels integrating unique identifiers, such as alphanumeric references, barcodes or radio frequency identification (RFID) means, on bottles of wine.

Such identification means improve the information relating to the labeled product but do not fully meet the need mentioned.

The invention in particular aims to meet the need relating to the more specific integration of a seal on a parcel.

More specifically, the invention aims to propose a parcel with a seal specially designed to be integrated into the parcel, and having an additional ability to control the condition of the seal, other than the ability relating to a visual on-site control of the condition of the seal.

The invention also aims to provide such a parcel that makes it possible to know with accuracy when the seal has been broken, for example during the opening of the parcel.

The invention also aims to provide such a parcel whose seal is simple to implement.

These aims, as well as others which will appear later, are achieved thanks to the invention which relates to a parcel comprising:
a container having a cavity, and a female member called first female member;
closing means, the parcel having a closed configuration in which the closing means prevent access to the cavity, and an open configuration in which the closing means allow access to the cavity;
a seal intended to guarantee a holding of the parcel in its closed configuration;
in which the seal comprises;
a male member called first male member, complementary to the first female member, the seal being intended to be attached onto the parcel in an attached position guaranteeing that the parcel is held closed in which the first male member is anchored and held captive in the first female member;
at least one irreversibly degradable part during a passage of the parcel, with the seal in its attached position, from the closed configuration to the open configuration or during an unsealing of the seal,
characterized in that the seal comprises a component for controlling the integrity of the seal, the control component being at least partially integrated into the degradable part;
and in that the parcel comprises an electronic unit for controlling the integrity of the seal, the electronic unit comprising:
means for detecting a degradation of the control component;
means for initiating the detection means during a positioning of the seal in its attached position.

The parcel according to the invention is provided with a seal specifically designed for the container.

Indeed, the seal must be anchored in the container and thus has a predetermined position when it is put into operation. This position corresponds to its position called “position guaranteeing that the parcel is held closed”.

Thanks to the electronic control unit, an additional control of the condition of the seal, other than a banal visual control of the seal, is made.

This control, made by the detection means, starts simply and automatically during the installation of the seal. This automatic start is permitted through the means for initiating the detection means, and the single action of anchoring the seal in its predetermined position triggers the initiation of the detection means.

The implementation of the seal is thus particularly simple and fast.

According to one preferred embodiment, the closing means have a female member called second female member, and in that the seal comprises;
a second male member complementary to the second female member, the second male member being intended to be anchored and held captive in the second female member in the attached position;
a body extending longitudinally between the male members and having said at least one degradable part, the body of the seal being positioned overlapping an interface between the container and the closing means in the attached position of the seal.

Thanks to this embodiment, the seal extends to the surface of the parcel between the two female members presented respectively by the container and by the closing means.

This seal is thus anchored on either side of the interface when it is in its attached position guaranteeing that the parcel is held closed.

In this case and according to one advantageous characteristic, in the attached position of the seal, the body of the seal matches a contour of the parcel between the first female member and the second female member.

By matching the contour of the parcel between the first female member and the second female member, then the seal is pressed against the contour of the parcel in its attached position, at least between its two male members.

In this way, the seal does not have any part extending freely from the parcel between its two male members and which could be accidentally torn off during a handling or a fall of the parcel.

According to one preferred solution, in the attached portion of the seal, the body of the seal is accommodated in grooves presented by the container and by the closing means, the body of the seal having a thickness smaller than or equal to the depth of each of the grooves.

In this way, the seal is protected inside the grooves during a handling of the parcel.

In other words, when it is in its attached position, then the seal does not protrude outside the grooves presented by the parcel.

If the parcel is brought into contact with a foreign body, at the level of the seal, then it is more than likely that the edges of the grooves are themselves in contact with this foreign body and that the seal is not subjected to any force likely to deteriorate it.

Preferably, the body has a central portion located between the first male member and the second male member, and bordered by two degradable parts, the central portion being intended to be detached during an unsealing of the seal.

The seal thus has an intuitive operation requiring, during an unsealing of the seal, a simple tearing, for example, of this central portion.

The degradable parts are then, for example, formed by pre-cuts weakening the body in a predetermined manner.

Advantageously, the control component comprises an electrically conductive track.

In this way, when the degradable part is irreversibly degraded during the passage of the parcel from its closed configuration to its open configuration or during an unsealing of the seal, then the electrical continuity of the electrically conductive track is broken and it is this rupture that can be detected through the detection means.

For example, a continuous or variable electric current, sent periodically by the detection means, can make it possible to know whether the electrically conductive track is intact or not.

In the event that the direct electric current or an electric pulse sent in the electrically conductive track does not succeed, then the seal is either degraded or absent, which corresponds to an unsealing of the seal.

According to one preferred solution;
the control component has at least one electrically conductive terminal;
the initiation means comprise a connector for each terminal of the control component, and, in the attached position of the seal, the connector(s) is/are brought into contact with the terminal(s).

Thanks to this solution, the simple affixing of the seal to the parcel makes it possible to establish the electrical contact between the connectors and the terminals.

This solution is particularly simple to implement.

Advantageously, the control component comprises an electronic member for wireless communication with the electronic unit.

In this way, the seal can send, without a wired connection, information to the electronic unit to inform it of its condition.

For example, the electronic wireless communication member may be a radio identification antenna (also designated by the acronym RFID) which would be coupled to the electrically conductive track of the control component which is integrated at least partially into the degradable part.

In this case, preferably, the control component comprises a memory integrating a unique identifier.

This makes it possible to know precisely which seal is located on the parcel.

This unique identifier makes it possible to avoid the use of incompatible or unaccepted seals in a traceability system implementing the parcel according to the invention.

According to one variant of embodiment, the electronic unit comprises means for wireless communication with a remote computer server, the electronic unit being configured to issue an alert to the remote computer server via the wireless communication means upon detection of a degradation of the control component by the detection means.

The parcel, thanks to this variant of embodiment, has the ability to communicate the condition of the seal to a remote computer server.

According to one possible application, the final recipient of the parcel can then be informed whether his parcel has been opened, or more specifically unsealed, prior to its receipt, while being aware of this event at the same time or shortly after its occurrence.

Other characteristics and advantages of the invention will appear more clearly upon reading the following description of various preferred embodiments of the invention, given by way of illustrative and non-limiting examples, and the appended drawings among which:

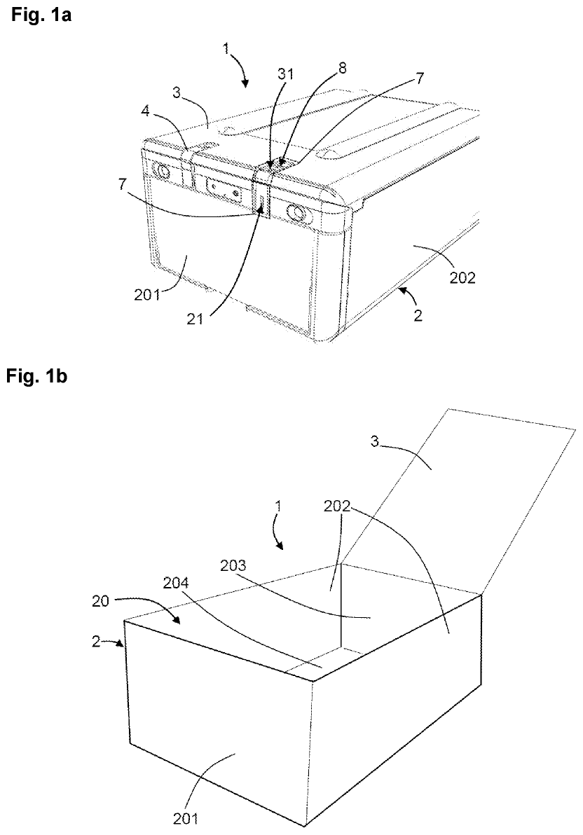

FIG. 1a is a schematic perspective top representation of a parcel according to the invention, in a closed configuration in which closing means prevent access to the contents of the parcel, the parcel being provided with a seal intended to guarantee the holding of the parcel in its closed configuration;

FIG. 1b is a simplified schematic perspective top representation of the parcel according to the invention, in an open configuration in which the closing means allow access to the parcel;

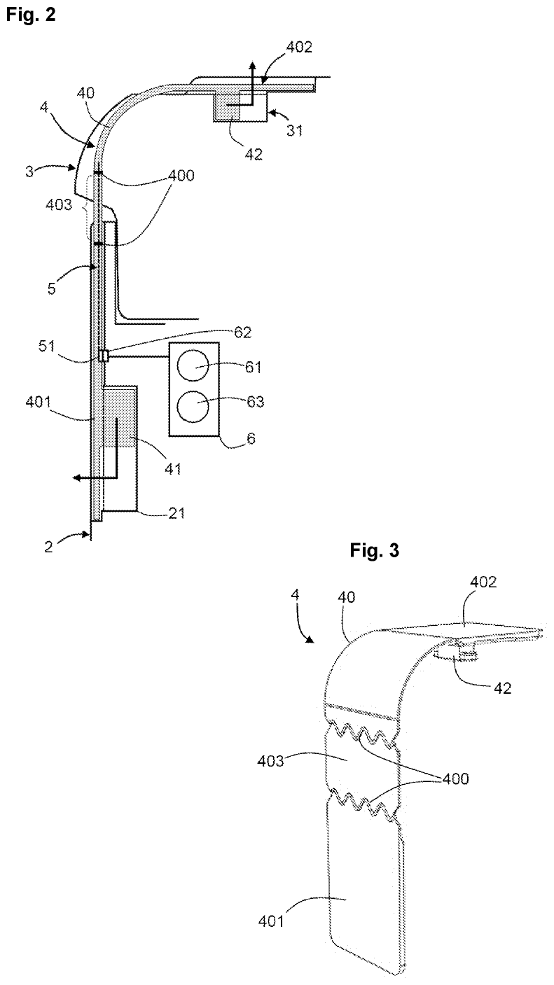

FIG. 2 is a schematic cross-sectional representation of the seal affixed to the parcel according to the invention;

FIG. 3 is a schematic perspective top representation of the seal;

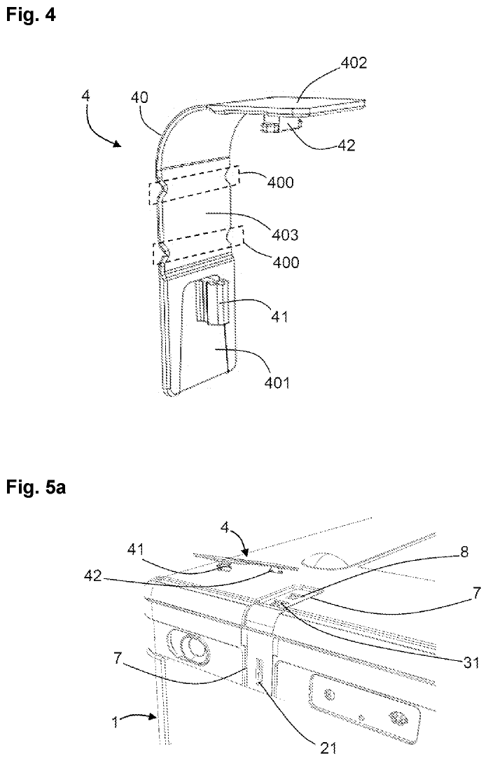

FIG. 4 is a schematic perspective top and rear representation of the seal;

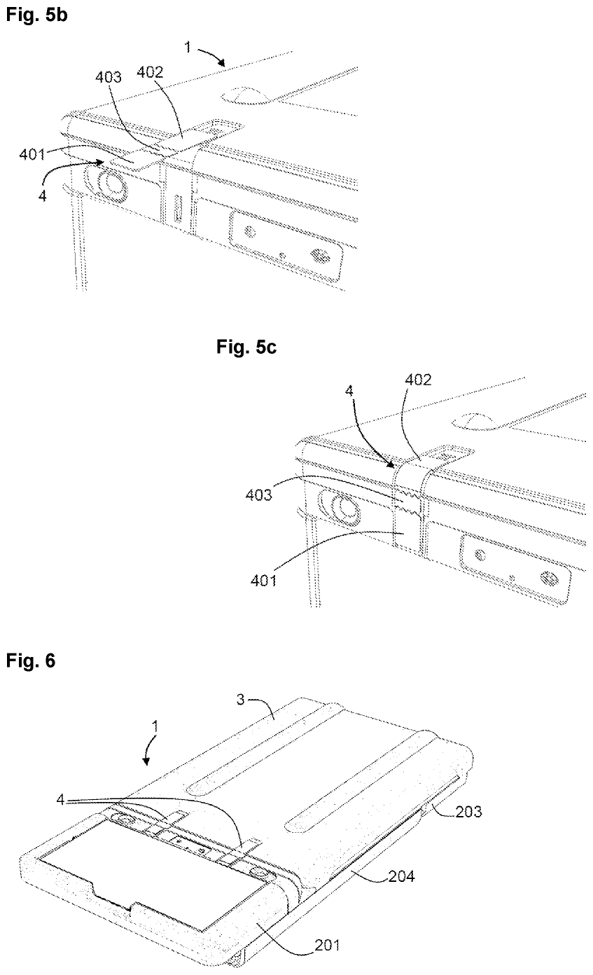

FIG. 5a is a schematic representation illustrating a step of affixing the seal to the parcel according to the invention;

FIG. 5b is a schematic representation illustrating a step of affixing the seal following that of FIG. 5a;

FIG. 5c is a schematic representation illustrating a step of affixing the seal following that of FIG. 5c;

FIG. 6 is a schematic perspective top representation of the parcel in a flat configuration and where two seals are affixed to the parcel.

With reference to FIGS. 1a, 1b and 6, a parcel 1 according to the invention is represented.

The parcel 1 comprises a container 2 which has a cavity 20 intended for example to accommodate an object intended to be transported.

The parcel 1 also comprises closing means 3 to obturate the cavity 20.

The closing means 3 are formed by a lid.

This lid is, still according to the present embodiment, movably mounted relative to the container 2. More specifically, the lid is movably mounted in rotation on the rear panel 203 of the container 2.

According to one possible embodiment, the lid can be removable and intended to be simply attached onto the container 2.

More specifically and with reference to FIGS. 1a and 1b, the parcel can adopt a closed configuration (FIG. 1a) or an open configuration (FIG. 1b).

In the closed configuration, the closing means 3 prevent access to the cavity 20, and in the open configuration the closing means 3 allow access to the cavity 20.

In these use and closed configurations, the container 2 is shaped to define the cavity 20. This container 2 in particular takes the form of a case.

According to the present embodiment and as detailed below, the parcel 1 can also adopt a flat configuration.

The container 2 more specifically comprises a bottom 204, as well as a peripheral rim composed of a front panel 201, two side panels 202 and a rear panel 203.

As illustrated in FIG. 6, the parcel 1 can be folded into a flat configuration. In this flat configuration, the side panels 202 are folded down on the bottom 204, the rear panel 203 is folded down in the extension of the bottom 204, and the front panel 201 and the lid (which forms the closing means 3) are folded down on the bottom 204 overlapping the side panels 202, the lid extending in the extension of the front panel 201.

In its flat configuration, the parcel 1 has minimal bulk.

According to the principle of the invention and with reference to FIGS. 1a to 6, the parcel 1 comprises at least one seal 4 which is intended to guarantee the holding of the parcel 1 in its closed configuration, that is to say to guarantee that the parcel 1 has been held in its closed configuration throughout the shipment.

For this purpose, the container 2 has a female member, called first female member 21, and the seal 4 comprises a male member, called first male member 41. The first male member 41 is complementary to the first female member 21.

The seal 4 is intended to be installed in a position attached onto the parcel 1, in which the seal guarantees that the parcel 1 is held closed, that is to say the parcel 1 has been held closed. In this position, the first male member 41 is anchored and held captive in the first female member 21.

According to the present embodiment, the closing means 3, formed by the lid, have a female member, called second female member 31. The seal 4 comprises another male member, called second male member 42. The second male member 42 is complementary to the second female member 31.

Like the first male member and the first female member, this second male member is intended to be anchored and held captive in the second female member in the attached position of the seal 4.

As illustrated in FIGS. 2 to 5, and still according to the principle of the invention, the seal 4 comprises at least one degradable part 400 during a passage of the parcel 1, with the seal 4 in its attached position, from the closed configuration to the open configuration or during an unsealing of the seal 4.

The or each degradable part 400 is irreversibly degradable. In other words, when the or each degradable part 400 is degraded, it cannot recover its non-degraded initial condition.

According to the present embodiment, the seal 4 comprises two degradable parts 400.

These degradable parts 400 are formed by pre-cuts, that is to say by cut lines initiating a cutout of the seal 4.

According to the present embodiment, the seal 4 comprises a body 40 which extends longitudinally between the male members and which has the degradable parts 400.

With reference to FIGS. 1a, 2 and 5c, the body 40 of the seal 4 is positioned overlapping an interface between the container 2 and the closing means 3 in the attached position of the seal 4.

More specifically, in this attached position of the seal 4, the body 40 of the seal matches a contour of the parcel 1 between the first female member 21 and the second female member 31.

This body 40 is in particular formed by a strip.

The body 40 has;
a first part 401, carrying the first male member 41 which protrudes from a lower face of the body 40, and
a second part 402, carrying the second male member 42 which protrudes from the lower face of the body 40.

The body 40 has a central portion 403 between the first part 401 and the second part 402.

In other words, this central portion 403 is located between the first male member 41 and the second male member 42.

The first part 401 and the second part 402 of the body 40 of the seal are separated from the central portion 403 by the two degradable parts 400. The central portion 403 is thus bordered by the two degradable parts 400, this central portion being intended to be detached during an unsealing of the seal 4.

With reference to FIG. 5c, the seal 4, and in particular its body 40, is flexible, which makes it possible to deform the seal 4 such that it matches the contour of the parcel 1.

According to the present embodiment and with reference to FIGS. 1a, 2, and 5a, the container 2 and the closing means 3 have grooves 7 for each seal 4. Each seal 4 is intended to be accommodated in the complementary grooves 7 and to be protected within these grooves. Indeed, the body 40 of the seal has a thickness smaller than or equal to the depth of the grooves 7. In this way, the body 40 of the seal does not protrude out of the grooves 7.

Referring to FIGS. 2, 3 and 4, the first male member 41 is formed by an elastically deformable hook.

More specifically, the first male member 41 takes the form of an arrow with a rigid central rod and two elastically deformable fins.

The two fins are elastically deformable so as to allow the insertion of the hook formed inside the first female member 21, by means of a forced folding of the fins. Once the first male member 41 is sufficiently depressed, the elastically deformable fins are deployed, tending to resume their rest position, thus achieving the anchoring of the first male member 41 in the first female member 21.

When the first male member 41 is in the first female member 21, it is blocked in position and can only be extracted by a sliding of the first male member 41 in a direction opposite to the second male member 42.

As illustrated in FIGS. 3 and 4, the second male member 42 takes the form of a non-elastically deformable single hook. This second male member 42 is intended to be inserted into the second female member 31.

Indeed, the second female member 31 comprises;
a rear hollow part in which the second male member 42 can be inserted, this rear hollow part being in the recess of the second male member 42;
a complementary front hollow part for insertion and blocking of the second male member 42;
the second male member being able to slide from the rear hollow part to the front hollow part of the second female member 31.

When the second male member 42 is in the front part of the second female member 31, it is blocked in position and can only be extracted through a sliding in the direction of the rear part.

With reference to FIGS. 5a to 5c, which illustrate a kinematics for positioning a seal 4, the second male member 42 must be inserted into the second female member 31 by first inserting the second male member 42 into the rear hollow part of the second female member 31. Then, the seal 4 and thus the second male member 42 must be slid in the direction of the first female member 21 to pass the second male member 42 in the front hollow part of the second female member 31.

To finish the installation of the seal 4, it suffices to clip the first male member 41 into the first female member 21 presented by the container 2.

Referring to FIG. 2, the seal 4 is held in position through the male members and the female members, as well as the body 40 of the seal 4 which is stretched between these members.

Following an unsealing of the seal 4 and more specifically a detachment of the central portion 403 of the body 40 from the seal 4, then the first part 401 of the body 40 of the seal 4 can be slid downwards, which makes it possible to disengage the first male member 41 from the cavity formed by the first female member 21, and to cause the second part 402 of the body 40 of the seal 4 to slide backwards to extract the second male member 42 from the cavity formed by the second female member 31.

Referring to FIG. 2 and as detailed below, the seal 4 comprises a component 5 for controlling the integrity of the seal 4 (represented in dotted lines).

This control component 5 is at least partially integrated into the degradable part 400.

The parcel 1 also comprises an electronic unit 6 for controlling the integrity of the seal 4.

This electronic unit 6 is housed in the cavity 20 or, more advantageously, in the thickness of a wall of the container 2, and more specifically in the thickness of the front panel 201.

The electronic unit 6 comprises means 61 for detecting a degradation of the component 5 for controlling the seal 4.

More particularly, the control component 5 passes through the degradable part(s) 400.

In this way, during an unsealing of the seal and during an irreversible degradation of one of the degradable parts 400, then the control component 5 is also degraded.

The detection means 61 of the electronic unit 6 are thus designed to detect a degradation of this control component 5.

The electronic unit 6 also comprises means for initiating the detection means 61 during a positioning of the seal 4 in its attached position.

These initiation means make it possible, as soon as the seal 4 is positioned on the parcel 1, to trigger the operation of the detection means 61.

Referring to FIG. 2, the control component 5 comprises an electrically conductive track 50.

This electrically conductive track 50 is a component of an electric circuit.

According to the present embodiment and still with reference to FIG. 2, the control component 5 has at least one electrically conductive terminal 51 coupled to the electrically conductive track 50.

In this case, the means for initiating the electronic unit 6 then comprise a connector 62 for each terminal 51 of the control component 5.

As illustrated in FIG. 2, then in the attached position of the seal 4, the connector(s) 62 are brought into contact with the terminal(s) 51.

The affixing of the seal 4 to the parcel 1 thus makes it possible to electrically couple the terminal(s) 51 presented by the seal to the connectors 62 presented by container 2 of parcel 1, to close the electric circuit.

According to one possible embodiment and not represented, the control component can also comprise an electronic member for wireless communication with the electronic unit 6. Such an electronic wireless communication member can be formed by an RFID antenna, in particular UHF (ultra high frequency) or NFC (near field communication), antenna associated with the electrically conductive track 50.

The electronic unit 6 is then provided with a transceiver sending a signal to the RFID antenna and intended to wait in return for a signal returned by the RFID antenna to check that the condition of the seal is still intact. In the event that a degradable part 400 is damaged, then the electrically conductive track 50 is broken and the RFID antenna cannot return a signal. The absence of return of a signal makes it possible to determine a degradation of the seal 4.

According to another possible embodiment, the control component can be formed by a magnetic element and the detection means 61 and the means for initiating the electronic unit 6 can then be formed by a Hall Effect sensor detecting the presence or the absence of the magnetism of the magnetic element. The absence of magnetism then corresponds to a degradation of the seal 4.

In order to prevent any fraud, that is to say the rapid replacement of the seal 4 with a magnet, the electronic unit 6 analyzes the variation of the magnetic field over a given period of time.

A too long period of absence of magnetism corresponds to a degradation of the seal 4. Also, if the sensor is under the effect of a strong magnetic source, making the sensor blind and the detection of the presence of the seal impossible, for a period greater than a threshold defined in the electronic unit 6, an alert for attempted fraud is generated.

The control component 5 can also comprise a memory integrating a unique identifier. Such a memory allows the electronic unit 6 to determine which seal 4 is coupled to the parcel 1.

The electronic unit 6 is, in this case, configured to be able to recognize the unique identifier, and validate or invalidate the seal 4.

Referring to FIG. 2, the electronic unit 6 may also comprise means for wireless communication 63 with a remote computer server.

In this case, the electronic unit 6 is configured to issue an alert to the remote computer server via the wireless communication means 63 upon detection of a degradation of the control component 5 by the detection means 61.

Referring to FIG. 6, the seal 4 can also be used when the parcel 1 is in its flat configuration. To this end, as illustrated by FIG. 1a, the parcel 1 is provided, for each seal 4, with a second anchor point 8 for each male member, that is to say for the first male member 41, or for the second male member 42.

This second anchor point 8 is designed to compensate, if necessary, for a difference in length developed between the first female member 21 and the second female member 31 when the parcel 1 is in its flat configuration compared to its shaped configuration.

According to the present embodiment illustrated in FIGS. 1a and 6, when the parcel 1 is in its flat configuration, it has a developed length between the two female members smaller than the developed length when it is in its use configuration.

Consequently, the second anchor point 8 is spaced apart from the second female member 31 to allow the seal 4 to also be compatible with this anchor system.

1.-10. (canceled)

11. A parcel comprising:
a container having a cavity, and a female member called first female member;
closing means, the parcel having a closed configuration in which the closing means prevent access to the cavity, and an open configuration in which the closing means allow access to the cavity;
a seal intended to guarantee a holding of the parcel in its closed configuration;
wherein the seal comprises;
a male member called first male member, complementary to the first female member, the seal being intended to be attached onto the parcel in an attached position guaranteeing that the parcel is held closed in which the first male member is anchored and held captive in the first female member;
at least one irreversibly degradable part during a passage of the parcel, with the seal in its attached position, from the closed configuration to the open configuration or during an unsealing of the seal,
wherein the seal comprises a component for controlling the integrity of the seal, the control component being at least partially integrated into the degradable part;
and wherein the parcel comprises an electronic unit for controlling the integrity of the seal, the electronic unit being housed in the cavity or in the thickness of a wall of the container, and comprising:
means for detecting a degradation of the control component;
means for initiating the detection means during a positioning of the seal in its attached position, the initiation means being designed to trigger the operation of the detection means as soon as the seal is positioned on the parcel.

12. The parcel according to claim 11, wherein the closing means have a female member called second female member,
and in that the seal comprises;
a second male member complementary to the second female member, the second male member being intended to be anchored and held captive in the second female member in the attached position;
a body extending longitudinally between the male members and having said at least one degradable part,
the body of the seal being positioned overlapping an interface between the container and the closing means in the attached position of the seal.

13. The parcel according to claim 12, wherein, in the attached position of the seal, the body of the seal matches a contour of the parcel between the first female member and the second female member.

14. The parcel according to claim 12, wherein, in the attached portion of the seal, the body of the seal is accommodated in grooves presented by the container and by the closing means, the body of the seal having a thickness smaller than or equal to the depth of each of the grooves.

15. The parcel according to claim 12, wherein the body has a central portion located between the first male member and the second male member, and bordered by two degradable parts, the central portion being intended to be detached during an unsealing of the seal.

16. The parcel according to claim 11, wherein the control component comprises an electrically conductive track.

17. The parcel according to claim 16, wherein;
the control component has at least one electrically conductive terminal;
the initiation means comprise a connector for each terminal of the control component, and in that, in the attached position of the seal, the connector(s) is/are brought into contact with the terminal(s).

18. The parcel according to claim 16, wherein the control component comprises an electronic member for wireless communication with the electronic unit.

19. The parcel according to claim 16, wherein the control component comprises a memory integrating a unique identifier.

20. The parcel according to claim 11, wherein the electronic unit comprises means for wireless communication with a remote computer server, the electronic unit being configured to issue an alert to the remote computer server via the wireless communication means upon detection of a degradation of the control component by the detection means.
